(19) United States
(12) Patent Application Publication
(10) Pub. No.: US 2021/0065257 A1
(43) Pub. Date: Mar. 4, 2021

(54) COUNTERBALANCING BIAS OF USER REVIEWS

(71) Applicant: INTERNATIONAL BUSINESS MACHINES CORPORATION, ARMONK, NY (US)

(72) Inventors: Raphael I. Arar, San Jose, CA (US); Guangjie Ren, Belmont, CA (US); Shun Jiang, San Jose, CA (US); Lei Huang, Mountain View, CA (US)

(21) Appl. No.: 16/551,973

(22) Filed: Aug. 27, 2019

(51) Int. Cl. G06Q 30/02; G06F 17/27

(52) U.S. Cl. CPC G06Q 30/0282; G06F 17/2785

(57) ABSTRACT

A method, a computer program product, and a computer system counterbalance a developed bias of user reviews. The method includes determining a developed bias of an existing plurality of first user reviews for a first item. The method includes determining a tendency value of a designated user indicative of a tendency of a user sentiment exhibited in user reviews for respective second items provided by the designated user deviating from an average sentiment of the respective second items. The method includes determining an influential prompt in which the designated user provides an input for the first item, the influential prompt being offset by an offset value based on the developed bias and the tendency value. The method includes prompting the designated user with the influential prompt and receiving the input from the designated user. The method includes updating the tendency value based on the input.

### BACKGROUND

The present invention relates generally to user review, and more particularly to counterbalancing a bias of user reviews developed by prior users and enhanced by current users.

User reviews, whether it be of a product, a system, or a method associated with an entity, have a tendency to veer toward an extreme positive or an extreme negative sentiment. The unique personalities associated with users of a review system may affect the overall sentiment of a review history for the entity. In crowdsourcing environments, where an aggregate of user reviews is made public, a user may be influenced by previously input user reviews, resulting in the user also leaving an extreme review. This process may cause an endless cycle that creates a social desirability bias, inviting other users to respond to surveys or review systems in a manner that will be viewed by others towards the social desirability bias.

### SUMMARY

The embodiments disclose a method, a computer program product, and a computer system for counterbalancing a developed bias of user reviews. The method comprises determining a developed bias of an existing plurality of first user reviews for a first item. The method comprises determining a tendency value of a designated user indicative of a tendency of a user sentiment exhibited in user reviews for respective second items provided by the designated user deviating from an average sentiment of the respective second items. The method comprises determining an influential prompt in which the designated user provides an input for the first item, the influential prompt being offset by an offset value based on the developed bias and the tendency value. The method comprises prompting the designated user with the influential prompt and receiving the input from the designated user. The method comprises updating the tendency value based on the input.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 depicts a schematic diagram of a user review counterbalance system 100, in accordance with an embodiment of the present invention.

FIG. 2 depicts a flowchart 200 illustrating the operations of a user review counterbalance program 122 of the user review counterbalance system 100 in counterbalancing a developed bias of user reviews, in accordance with an embodiment of the present invention.

FIG. 3 depicts a block diagram depicting the hardware components of the user review counterbalance system 100 of FIG. 1, in accordance with an example embodiment of the present invention.

FIG. 4 depicts a cloud computing environment, in accordance with an embodiment of the present invention.

FIG. 5 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete, and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements of various embodiments of the present invention.

Embodiments of the present invention disclosure are directed to a method, computer system, and computer program product for counterbalancing a developed bias of user reviews. As will be described in greater detail herein, the present invention is configured to determine how a user review from a designated user is normalized based on a developed bias for a selected item and a tendency that the designated user provides user reviews for other items. Using historical information to determine the tendency of the designated user, the example embodiments may determine an offset to be applied to a user review provided by the designated user for the selected item to minimize a deviation from the developed bias. Detailed implementation of the present invention follows.

While certain conventional approaches try to overcome a social desirability bias with a selection of indirect and direct questions, such approaches are unclear as to how such questions are selected and further, asked of the user. For example, a first conventional approach may use a strict ontology to remove ambiguity from communications. However, the first conventional approach does not provide an offset. In another example, a second conventional approach may use context of user inputs to fulfill anticipated actions. However, the second conventional approach does not utilize a hysteresis to analyze and approach a ground truth of understanding. In a further example, a third conventional approach may attempt to identify a bias in natural language of inputs without any implementation of using such bias. As is evident, the conventional approaches do not provide an approach in which operations are performed based on a sentiment analysis. The example embodiments support a systematic intervention by providing an influential prompt selected with reference to a defined weighting system. Such weighting system may be defined using both personal data and crowdsourced data. The example embodiments may utilize such weighting system to counterbalance, and further, overcome social desirability bias within the realm of a user review system.

The example embodiments are described with regard to counterbalance of a developed bias of user reviews. However, the example embodiments may also be applied and/or modified to be used with other entities of bias that may or may not be related to user reviews. For example, the example embodiments may also be used for bias regarding gender, age, religion, sexual orientation, advertisements, etc.

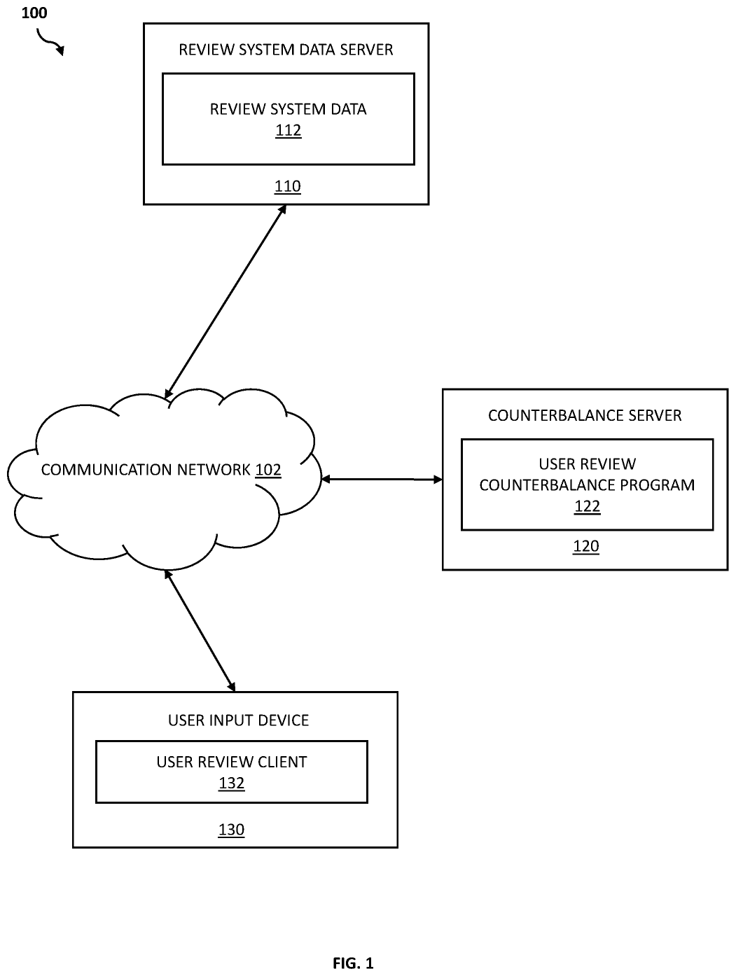

FIG. 1 depicts a user review counterbalance system 100, in accordance with embodiments of the present invention. In the example embodiment, the user review counterbalance system 100 may include one or more review system data servers 110, one or more counterbalance servers 120, and one or more user input devices 130, which may all be interconnected via a communication network 102. While programming and data of the example embodiments may be stored and accessed remotely across several servers via the communication network 102, programming and data of the example embodiments may alternatively or additionally be stored locally on as few as one physical computing device or amongst other computing device than those depicted.

In the example embodiment, the communication network 102 may be a communication channel capable of transferring data between the connected devices of the user review counterbalance system 100. In the example embodiment, the communication network 102 may be the Internet, representing a worldwide collection of networks and gateways to support communications between devices connected to the Internet. Moreover, the communication network 102 may utilize various types of connections such as wired, wireless, fiber optic, etc. which may be implemented as an intranet network, a local area network (LAN), a wide area network (WAN), or a combination thereof. In further embodiments, the communication network 102 may be a Bluetooth network, a WiFi network, or a combination thereof. In yet further embodiments, the communication network 102 may be a telecommunications network used to facilitate telephone calls between two or more parties comprising a landline network, a wireless network, a closed network, a satellite network, or a combination thereof. In general, the communication network 102 may represent any combination of connections and protocols that will support communications between connected devices. For example, the communication network 102 may also represent direct or indirect wired or wireless connections between the components of the user review counterbalance system 100 that do not utilize the communication network 102.

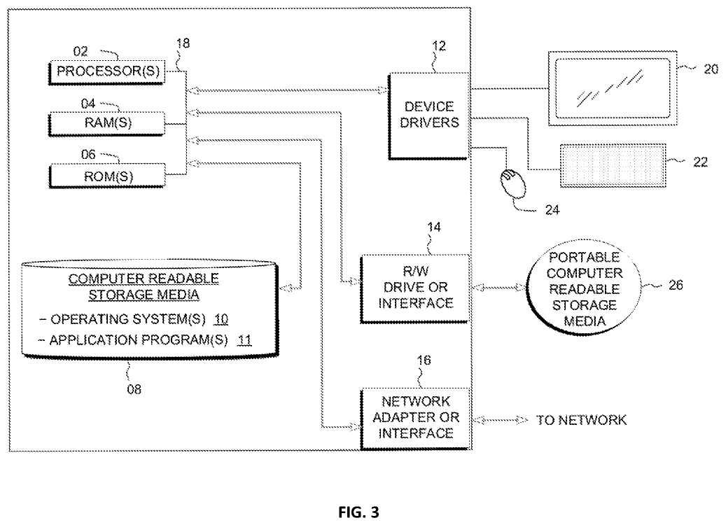

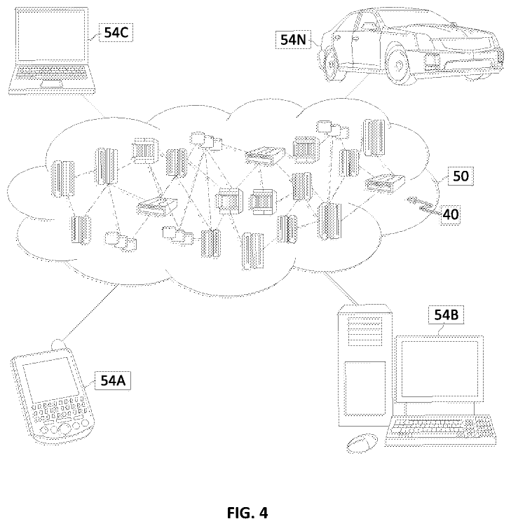

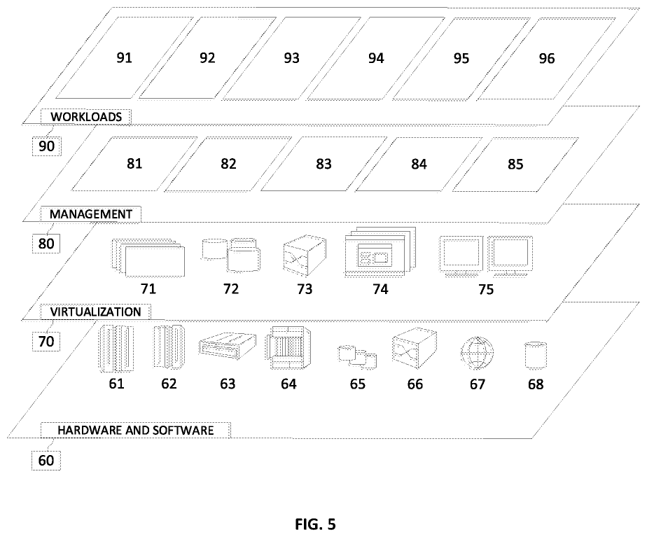

In the example embodiment, the review system data server 110 may include one or more review system data 112 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an Internet of Things (IoT) device, or any other electronic device or computing system capable of receiving and sending data to and from other computing devices. While the review system data server 110 is shown as a single device, in other embodiments, the review system data server 110 may be comprised of a cluster or plurality of computing device, in a modular manner, etc., working together or working independently. The review system data server 110 is described in greater detail as a hardware implementation with reference to FIG. 3, as part of a cloud implementation with reference to FIG. 4, and/or as utilizing functional abstraction layers for processing with reference to FIG. 5.

In the example embodiment, the review system data 112 may include a plurality of reviews input by a plurality of users associated with one or more products, programs, or methods (e.g., a review item) associated with one or more entities. A review may be defined as a user's personal opinion regarding the associated review item (e.g., “This item was extremely useful”). Additionally, the review system data 112 may store relevant review information, which may include, but is not limited to, the time the review was submitted, any feedback to the review from the user by one or more different users (e.g., a different user endorsing the review of the user), etc.

The review system data 112 may also include data associated with the user who submitted the review (e.g., user data). User data may include, but is not limited to, a user's previously input reviews, a stored tendency value, a name, an age, a gender, a race, a geographical location, a marital status, an occupation, an education, etc. In the example embodiment, user data may be stored in association with a user by a developed unique link (e.g., a user account). In embodiments, the user data may be acquired from a plurality of user inputs utilizing the user input device 130. In other embodiments, user data may automatically be identified from the internal storage databases of the user input device 130 (e.g., a user's smartphone contacts).

Further, the review system data 112 may include data associated with an item being reviewed (e.g., item data). Item data may include, but is not limited to, an item's overall review, an overall review without the use of counterbalancing questions, a manufacturer and/or developer, a size, a weight, a price, a category (e.g., toy, application, clothing, etc.), a material composition (e.g., plastic, wood, cotton, etc.), a guaranteed warranty, associated items (e.g., a canopy cover may be associated with a canopy frame), frequently related purchased items (e.g., Application B may be frequently purchased by users who purchased Application A), etc. In the example embodiment, the item data may be stored in association with a review item by a developed unique link (e.g., a serial number).

Even further, the review system data 112 may include data associated with an influential prompt that may be prompted to a user before a user reviews a product (e.g., prompt data). Prompt data may include, but is not limited to, a plurality of questions that the user review counterbalance program 122 may prompt to a user to influence the user to counterbalance the existing bias of the existing reviews with the review that the user may input. Further, the prompt data may also include an offset strength associated with each question within the plurality of questions. The offset strength of an influential prompt may be defined as an average influence the prompt has on the user. The influence may be calculated as a difference between the previously calculated tendency value of the user and the actual value that the user was different from the average. For example, if the user tends to review a review item at a tendency value of 0.30 lower than the average, but after receiving the prompt, rates the review item at an actual value of 0.10 lower than the average, the question may be defined to have an offset strength of 0.2. Further, the prompt data may also include the effectiveness of the influential prompt associated with each question.

The example embodiment utilizing a review system data server 110 including the review system data 112 is only for illustrative purposes. Those skilled in the art will understand that the review system data server 110 and the review system data 112 may represent other entities with corresponding data within the scope of the example embodiments.

In the example embodiment, the counterbalance server 120 may include a user review counterbalance program 122. In embodiments, the counterbalance server 120 acts as a server in a client-server relationship with the user review client 132 as well as in a communicative relationship with the review system data server 110 and a user input device 130 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the counterbalance server 120 is shown as a single device, in other embodiments, the counterbalance server 120 may be comprised of a cluster or plurality of computing devices, working together or working independently. The counterbalance server 120 is described in greater detail as a hardware implementation with reference to FIG. 3, as part of a cloud implementation with reference to FIG. 4, and/or as utilizing functional abstraction layers for processing with reference to FIG. 5.

In the example embodiment, the user review counterbalance program 122 may be a software, hardware, and/or firmware application capable of receiving the review system data 112. The user review counterbalance program 122 may be capable of detecting an existing developed bias within a designated plurality of user reviews associated with a designated review item. Further, the user review counterbalance program 122 may influence the current user to counterbalance the detected bias within the designated plurality of user reviews, based on a developed weighting system. In embodiments, the weighting system may be based on the review system data 112. In embodiments, such influence of the user review counterbalance program 122 may be in the form of a question, a statement, a declarative prompt, etc.

In the example embodiment, the user input device 130 may include a user review client 132, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the user input device 130 is shown as a single device, in other embodiments, the user input device 130 may be comprised of a cluster or plurality of computing devices, in a modular manner, etc., working together or working independently. The user input device 130 is described in greater detail as a hardware implementation with reference to FIG. 3, as part of a cloud implementation with reference to FIG. 4, and/or as utilizing functional abstraction layers for processing with reference to FIG. 5.

In the example embodiment, the user review client 132 may act as a client in a client-server relationship and may be a software, hardware, and/or firmware-based application capable of generating and transferring data input by a user from the user input device 130 to other devices of the user review counterbalance system 100. In embodiments, the user review client 132 may utilize various wired and wireless connection protocols for data transmission and exchange, including Bluetooth, 2.4 gHz and 5 gHz Internet, near-field communication, Z-Wave, Zigbee, etc.

The user review client 132 may allow a user to interact with the user review counterbalance program 122 as well as input data into the review system data 112 (e.g., user data, item data, reviews, etc.). Reviews, in the example embodiment, may be entered manually by a user. A manual input may utilize a graphical user interface (e.g., GUI) of the user review client 132, prompting the user to input data. In general, a GUI may allow a user to interact with electronic devices through graphical icons and visual indicators. The user may utilize external components 22, 24 (e.g., a keyboard, a mouse) of FIG. 3 to input data.

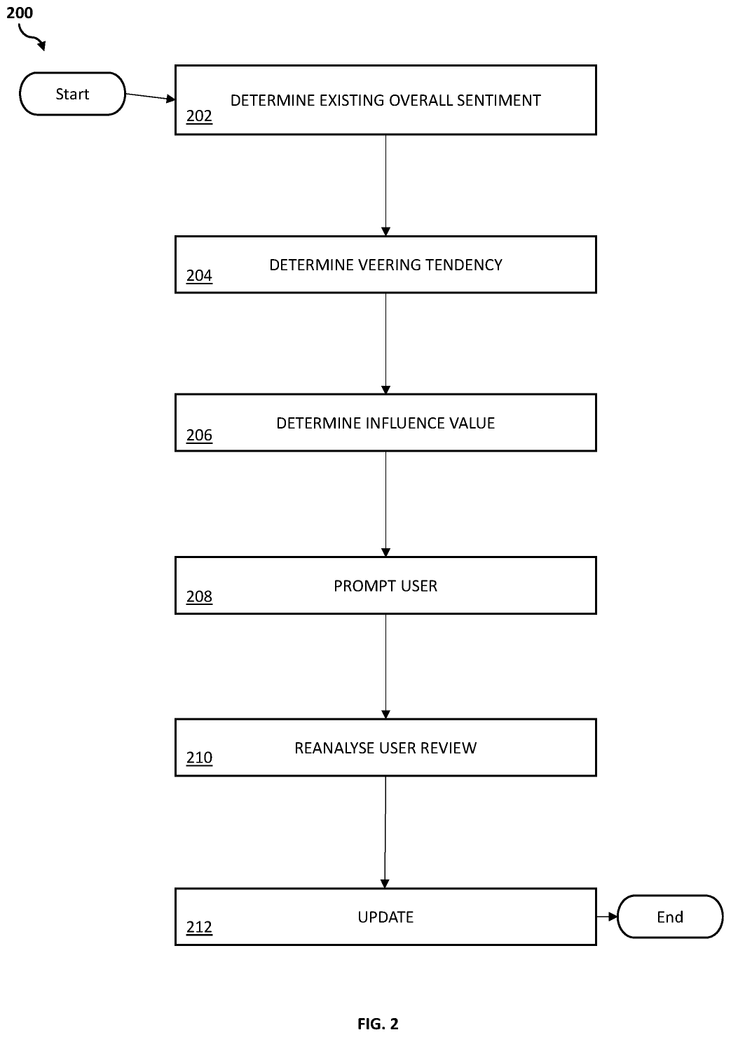

FIG. 2 illustrates the operations of the user review counterbalance program 122 of the user review counterbalance system 100 in counterbalancing a developed bias of user reviews, in accordance with an embodiment of the present invention.

The user review counterbalance program 122 may determine the overall sentiment of existing reviews (step 202). The user review counterbalance program 122 may obtain the plurality of review system data 112 (e.g., existing reviews) associated with a desired review item, from the review system data server 110. In the example embodiment, the user review counterbalance program 122 may utilize the communicative properties of the communication network 102 to remotely obtain data from the review system data server 110. In other embodiments, wherein the user review counterbalance program 122 is located on the same device as the review system data 112, the communication network 102 may not be used.

The user review counterbalance program 122 may then parse through the existing plurality of obtained reviews and determine the overall sentiment of the plurality of existing reviews associated with the designated review item. In the example embodiment, the user review counterbalance program 122 may utilize linguistic analysis (e.g., natural language processing) to transform the obtained plurality of reviews into an aggregated, linguistically understood, normalized set of data. In general, linguistic analysis may make use of rule-based analysis modules and deep learning within the user review counterbalance program 122. Deep learning may be used to build neural networks, and further, perform classification tasks directly from images, text, sound, etc. Normalization, in general, organizes a plurality of data (e.g., the plurality of reviews) to allow for a more cohesive and logical comparison.

In the example embodiment, linguistic analysis of the obtained plurality of reviews may allow the user review counterbalance program 122 to understand the correlation between the linguistic features of each sample of written text (e.g., each existing reviews) and known emotional and language tones. The correlation may be understand with correlative values, which may include, but are not limited to, scores of relational tone influence (e.g., “The user review appears related to a slightly negative tone at 0.4”), categorial identifiers (e.g., “The user review appears to be influenced by an aggressive tone”), and relative values (e.g., “The user review appears to be more negative than the average user review”). In the example embodiment, review correlative values may be normalized to a numerical scale representing a spectrum of scalar values associated with a sentiment (e.g., a scale ranging from −1 to 1, representing the scale of sentiments from hate to love, respectively). Scalar values may be identified and determined using keywords found within the reviews that may match a non-extreme sentiment. For example, the sentiment scalar values for hate/love, moving from −1 to 1, may be dislike (e.g., −1), neutral (e.g., 0), and like (e.g., 1). Sentiments may include, but are not limited to, acceptance, admiration, aggressiveness, amazement, anger, annoyance, anticipation, apprehension, awe, boredom, confidence, contempt, disapproval, disgust, distraction, ecstasy, fear, grief, interest, joy, loathing, love, optimism, pensiveness, rage, remorse, sadness, serenity, submission, surprise, tentativeness, terror, trust, vigilance, etc. In embodiments, the scale intervals may be automatically defined by user review counterbalance program 122 utilizing a machine learning technique. In other embodiments, the scalar intervals may be predefined by a user interacting with user review counterbalance program 122.

In the example embodiment, the plurality of correlative values may be averaged to define the overall sentiment of the existing user review data. In another embodiment, the user review counterbalance program 122 may analyse the plurality of existing user reviews as a whole, obtaining only one correlative value to define the overall sentiment of the existing reviews.

As an illustrative example, a User A (e.g., who is age 20) wants to input a review for gaming Application B. Application B has been previously reviewed by User B (e.g., who is age 4), User C (e.g., who is age 6), and User D (e.g., who is age 9). The user review counterbalance program 122 performs linguistic analytics on the reviews of User B, User C, and User D and averages the correlative values to determine that the existing reviews are negative, ranking at −0.40 on a scale of −1 being disgust and 1 being fondness.

The user review counterbalance program 122 may determine a veering tendency of a user (step 204). The veering tendency may relate to a tendency of a sentiment by which the user provides user reviews relative to an average sentiment. For example, the veering tendency may be a tendency value by which a sentiment of a user review for a given item by a designated user deviates from an average sentiment of user reviews from other users for the given item. In the example embodiment, the user review counterbalance program 122 may first obtain the plurality of reviews associated with a designated user (e.g., the plurality of reviews input solely by User A) from the user data of the review system data 112. The user review counterbalance program 122 may utilize the communicative properties of the communication network 102 to remotely obtain data from the review system data server 110. In other embodiments, wherein the user review counterbalance program 122 is located on the same device as the review system data 112, the communication network 102 may not be used.

The user review counterbalance program 122 may then parse through the obtained plurality of reviews input by the designated user and determine the overall tendency of the user. The overall tendency, in the example embodiment, may be defined as the inclination of the user to review a review item with a specific sentiment (e.g., User A is more likely to review a product as negative). To determine the overall tendency (e.g., the veering tendency), the user review counterbalance program 122, in the example embodiment, may obtain the correlative value of each review input by the designated user (e.g., user reviews) utilizing linguistic analytics and then, compare such correlative value against the average correlative value of the existing reviews associated with the review item. In the example embodiment, such comparison to the average allows the correlative data of the user, further, the tendency of the user, to be normalized against the plurality of existing user reviews.

In other embodiments, the user review counterbalance program 122 may analyse the plurality of user reviews as a whole, obtaining only one average correlative value of the reviews input by the designated user. Such average correlative value, in such embodiment, may be compared to the average correlative value of the plurality of existing reviews of the plurality of products reviewed by the designated user.

In the example embodiment, the tendency value may be the difference between the average of other users' existing reviews and the user's existing review (e.g., −0.30, +0.30, respectively). In other embodiments, a user's tendency may be categorical (e.g., generally more negative). In further embodiments, a user's tendency may be the numerical value according to the normalized scale previously defined, nonrelative to the average (e.g., −0.95).

In the example embodiment, the tendency value of the user (e.g., the difference of existing review overall sentiment correlative values and designated user sentiment correlative values) may be stored within user data associated with the user of the review system data 112. In embodiments wherein the user review counterbalance program 122 is remotely located to the counterbalance server 120, the communication network 102 may transfer the tendency value to the review system data server 110.

In furthering the previous example, the user review counterbalance program 122 determines the review tendency of User A. As seen in Table 1, the User A tends to be more negative than the average user (e.g., by an average correlative value amounting to −0.30: the sum of the differences for Toy 1, Toy 2, and Toy 3 divided by the total number of entries).

TABLE 1

| | Existing Review | User A | |
|---|---|---|---|
| | Overall Sentiment | Sentiment | |
| Review | −1 (boring) - - - 1 | −1 (boring) - - - 1 | |
| Item | (entertaining) | (entertaining) | Difference |
| Toy 1 | 0.30 | 0.10 | −0.20 |
| Toy 2 | −0.70 | −1.00 | −0.30 |
| Toy 3 | 0.90 | 0.50 | −0.40 |

The user review counterbalance program 122 may determine an influence value (step 206). In general, an influence value may represent the weighted tendency of a user to further counterbalance the existing review overall sentiment. In the example embodiment, the user review counterbalance program 122 may define a weighting system wherein such influence value is determined by the relationship of previously obtained data to the offset strength of the influential prompt the user should be further prompted. In such embodiment, the user review counterbalance program 122 may obtain the review system data 112 and assign weighted values to each variable of the review system data 112 to define the user specific weighting system. A variable, in such embodiment, may represent a unique set of data (e.g., existing review overall sentiment, tendency value, age category of the user, etc.). In one embodiment, the influence value may have a one-to-one relationship with the tendency value of the user. In other embodiments, the influence value may be made up of, for example, a 70% influence from the tendency value of the user and a 30% influence from the existing review overall sentiment. In the example embodiment, weighted values and corresponding variables may be automatically defined, utilizing machine learning, by the user review counterbalance program 122. In other embodiments, the weighted values and corresponding variables may be defined by the user review client 132 of the user input device 130.

In the example embodiment, the determined influence value may be stored within the user data associated with the user of the user review counterbalance program 122 within the review system data 112.

In furthering the previously drawn out example, the user review counterbalance program 122 may obtain the existing review overall sentiment of Application B to amount to −0.40. The user review counterbalance program 122 may then obtain the tendency value of User A to be −0.30. The user review counterbalance program 122 may also obtain user data of User A. The user review counterbalance program 122 may then, using the obtained data, calculate the tendency value of User A according to the following defined weighting Formula 1 utilizing an age variable:

Influence value=1.70x+0.40y−0.002z (Formula 1)

wherein, x represents the tendency value, y represents the existing review overall sentiment of the review item, z represents the age of the user, and the coefficients represent a degree to which these values affect the influence value. With such defined weightings, the influence value of User A for review item Application B is calculated to be −0.63. Such influence value of User A for Application B represents the determined fact that User A tends to be more negative than the average existing review overall sentiment, but also falls within an age category (18 years-20 years) that tends, in general, to be more positive.

The user review counterbalance program 122 may prompt the user (step 208). In general, guidance of the user may allow for an overall user sentiment score equilibrium as well as a review item-level sentiment score equilibrium for normalization purposes. In the example embodiment, the user review counterbalance program 122 may obtain the determined influence value of the user in association with the designated item. The user review counterbalance program 122 may then select an influential prompt with an equal but opposite offset strength of the influence value. In the example embodiment, the user review counterbalance program 122 may parse through the review system data 112 of the review system data server 110 to select the most effective influential prompt equal but opposite to the influence value of the user associated with the designated review item.

In embodiments, wherein no influential prompt has an offset strength equal but opposite to the influence value of the user, the user review counterbalance program 122 may generate an influential prompt in current time. Such automatic generation may make use of a machine learning technique, such as natural language processing, to compile words associated with certain sentiment scores to influence the user of the user review counterbalance program 122 to an equivalent degree that the influence value has previously had on the user.

In other embodiments, wherein no influential prompt has an offset strength equal but opposite to the influence value of the user, the user review counterbalance program 122 may select an influential prompt with an offset strength closest to the influence value of the user (e.g., a predetermined value based on available factors).

In the example embodiment, the user review counterbalance program 122 may then display the selected influential prompt to the user. In at least one embodiment, the user review counterbalance program 122 may transfer the influential prompt selected through the communication network 102 to the user input device 130 for display to the user review client 132. In at least one embodiment, the user review counterbalance program 122 may make use of a GUI.

In furthering the previous example, the user review counterbalance program 122 parses through the review system data 112 to obtain the following review system data with an equal but opposite offset strength to the influence value previously calculated for User A as −0.63. Thus, the offset strength may be set as 0.63 (e.g., equal but opposite).

| Influential Prompt | Offset Strength |
|---|---|
| “What did you like about this product?” | 0.63 |

The user review counterbalance program 122 may then display such influential prompt to the user of the user review counterbalance program 122. The response from the designated user may incorporate the offset strength to guide the designated user to an overall sentiment score equilibrium associated with the designated user as well as an item-level sentiment score equilibrium.

The user review counterbalance program 122 may re-analyse the designated user (step 210). In the example embodiment, after receiving a review from the user associated with the previously displayed influential prompt, the user review counterbalance program 122 may analyse the obtained review. Analysis may include use of linguistic analytics to transform the obtained review into a linguistically understood form of data. In such example embodiment, the obtained review may be given a correlative value to store within the review system data 112. In embodiments, the user review counterbalance program 122 may utilize such stored correlative value to improve the accuracy and efficiency of future applications of the user review counterbalance program 122.

In furthering the previous example, the user review counterbalance program 122 obtains the input review of User A for Application B that reads, “This application was overall disappointing. However, I did love the three-dimensional graphics added in the update.” The user review counterbalance program 122 then analyses such review and determines such review to have a correlative value of −0.1 on the sentiment spectrum of disgust to fondness.

The user review counterbalance program 122 may update necessary elements of the user review counterbalance program 122 for a more accurate future prompting (step 212). In the example embodiment, the user review counterbalance program 122 may reevaluate the tendency value of the user to include the most recent input review. Further, the user review counterbalance program 122 may adjust the weightings of the system based on the accuracy of the system in prompting the user. Accuracy, in the example embodiment, may be defined as how close the user review counterbalance program 122 brought the user to the desired equilibrium. In the example embodiment, the user review counterbalance program 122 may store the updated weighting system within the review system data 112 of the review system data server 110. In other embodiments, the weighting system may be stored within the user input device 130.

In furthering the previously enumerated example, the user review counterbalance program 122 reevaluates the tendency value of the user to include the newly added review to be −0.15 from a previous −0.30. Additionally, the user review counterbalance program 122 determines the weighting system brought the user close to equilibrium, however, could still use some improvement. The weightings of the weighting system were adjusted slightly to become 1.80x+0.40y−0.002z. Such adjusted weighting system is then stored within the review system data 112 of User A.

FIG. 3 depicts a block diagram of devices within the user review counterbalance system 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided.

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and counterbalance processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for counterbalancing a bias of user reviews, the method comprising:
determining a developed bias of an existing plurality of first user reviews for a first item;
determining a tendency value of a designated user indicative of a tendency of a user sentiment exhibited in user reviews for respective second items provided by the designated user deviating from an average sentiment of the respective second items;
determining an influential prompt in which the designated user provides an input for the first item, the influential prompt being offset by an offset value based on the developed bias and the tendency value;
prompting the designated user with the influential prompt;
receiving the input from the designated user; and
updating the tendency value based on the input.

2. The method of claim 1, wherein determining the developed bias of the existing plurality of first user reviews comprises:
receiving the existing plurality of user reviews associated with the first item;
determining a plurality of correlations for each of the user reviews provided by the designated user based on linguistic features of the user reviews provided by the designated user and predetermined emotional and language tones;
normalizing the plurality of correlations; and
aggregating the normalized correlations to determine an overall sentiment corresponding to the developed bias.

3. The method of claim 1, wherein determining the tendency value of the designated user comprises:
receiving the plurality of user reviews for respective second items provided by the designated user; and
determining an average deviation of the user reviews of the designated user from an average aggregated normalized plurality of defined correlations associated with the second items.

4. The method of claim 1, wherein determining the influential prompt comprises:
determining a multi-variable weighting system based on the developed bias and the tendency value of the designated user.

5. The method of claim 4, further comprising:
modifying the multi-variable weighting system based on the developed bias and the updated tendency value of the designated user.

6. The method of claim 4, wherein the multi-variable weighting system includes an age variable based on an age of the designated user.

7. The method of claim 1, wherein prompting the designated user with the influential prompt comprises:
determining a plurality of prompts associated with a respective offset strength; and
selecting one of the prompts having the respective offset strength that is equal and opposite to an influence value that is based on the tendency value of the designated user.

8. A computer program product for counterbalancing a bias of user reviews, the computer program product comprising:
one or more non-transitory computer-readable storage media and program instructions stored on the one or more non-transitory computer-readable storage media capable of performing a method, the method comprising:
determining a developed bias of an existing plurality of first user reviews for a first item;
determining a tendency value of a designated user indicative of a tendency of a user sentiment exhibited in user reviews for respective second items provided by the designated user deviating from an average sentiment of the respective second items;
determining an influential prompt in which the designated user provides an input for the first item, the influential prompt being offset by an offset value based on the developed bias and the tendency value;
prompting the designated user with the influential prompt;
receiving the input from the designated user; and
updating the tendency value based on the input.

9. The computer program product of claim 8, wherein determining the developed bias of the existing plurality of first user reviews comprises:
receiving the existing plurality of user reviews associated with the first item;
determining a plurality of correlations for each of the user reviews provided by the designated user based on linguistic features of the user reviews provided by the designated user and predetermined emotional and language tones;
normalizing the plurality of correlations; and
aggregating the normalized correlations to determine an overall sentiment corresponding to the developed bias.

10. The computer program product of claim 8, wherein determining the tendency value of the designated user comprises:
receiving the plurality of user reviews for respective second items provided by the designated user; and
determining an average deviation of the user reviews of the designated user from an average aggregated normalized plurality of defined correlations associated with the second items.

11. The computer program product of claim 8, wherein determining the influential prompt comprises:
determining a multi-variable weighting system based on the developed bias and the tendency value of the designated user.

12. The computer program product of claim 11, further comprising:
modifying the multi-variable weighting system based on the developed bias and the updated tendency value of the designated user.

13. The computer program product of claim 11, wherein the multi-variable weighting system includes an age variable based on an age of the designated user.

14. The computer program product of claim 8, wherein prompting the designated user with the influential prompt comprises:
determining a plurality of prompts associated with a respective offset strength; and
selecting one of the prompts having the respective offset strength that is equal and opposite to an influence value that is based on the tendency value of the designated user.

15. A computer system for counterbalancing a bias of user reviews, the computer system comprising:
one or more computer processors, one or more computer-readable storage media, and program instructions stored on the one or more of the computer-readable storage media for execution by at least one of the one or more processors capable of performing a method, the method comprising:
determining a developed bias of an existing plurality of first user reviews for a first item;
determining a tendency value of a designated user indicative of a tendency of a user sentiment exhibited in user reviews for respective second items provided by the designated user deviating from an average sentiment of the respective second items;
determining an influential prompt in which the designated user provides an input for the first item, the influential prompt being offset by an offset value based on the developed bias and the tendency value;
prompting the designated user with the influential prompt;
receiving the input from the designated user; and
updating the tendency value based on the input.

16. The computer system of claim 15, wherein determining the developed bias of the existing plurality of first user reviews comprises:
receiving the existing plurality of user reviews associated with the first item;
determining a plurality of correlations for each of the user reviews provided by the designated user based on linguistic features of the user reviews provided by the designated user and predetermined emotional and language tones;
normalizing the plurality of correlations; and
aggregating the normalized correlations to determine an overall sentiment corresponding to the developed bias.

17. The computer system of claim 15, wherein determining the tendency value of the designated user comprises:
receiving the plurality of user reviews for respective second items provided by the designated user; and
determining an average deviation of the user reviews of the designated user from an average aggregated normalized plurality of defined correlations associated with the second items.

18. The computer system of claim 15, wherein determining the influential prompt comprises:
determining a multi-variable weighting system based on the developed bias and the tendency value of the designated user.

19. The computer system of claim 18, further comprising:
modifying the multi-variable weighting system based on the developed bias and the updated tendency value of the designated user.

20. The computer system of claim 15, wherein prompting the designated user with the influential prompt comprises:
determining a plurality of prompts associated with a respective offset strength; and
selecting one of the prompts having the respective offset strength that is equal and opposite to an influence value that is based on the tendency value of the designated user.
